(19) United States
(12) Patent Application Publication
(10) Pub. No.: US 2020/0013066 A1
(43) Pub. Date: Jan. 9, 2020

(54) SYSTEM, METHOD, AND PROGRAM FOR DISPLAYING REGISTRATION STATUS OF CREDIT CARD

(71) Applicant: OPTiM Corporation, Saga-shi (JP)

(72) Inventor: Shunji SUGAYA, Tokyo (JP)

(21) Appl. No.: 16/065,840

(22) PCT Filed: Mar. 31, 2017
(86) PCT No.: PCT/JP2017/013827

§ 371 Date: Jun. 25, 2018

(51) Int. Cl. G06Q 20/40; G06Q 20/24

(52) U.S. Cl. CPC G06Q 20/4093; G06Q 20/24

(57) ABSTRACT

The system collects the registration status of a credit card in an EC site and organizes and displays the registration status by a credit card. The system receives a credit card to be registered, registers the received credit card in a predetermined EC site, collects the registration status of the plurality of credit cards registered in the plurality of EC sites, the plurality of credit cards being received and registered in the EC sites, and organizes and displays the collected registration status by a credit card.

### TECHNICAL FIELD

The present invention relates to a system, a method, and a program for displaying the registration status of a credit card in an electronic commerce site (hereinafter referred to as “EC site”).

### BACKGROUND ART

Recently, credit cards have become widely used, and one person or company holds two or more credit cards. The credit card holders may make settlement through credit card transaction on various EC sites. For example, a settlement management device that improves the convenience of settlement through a plurality of settlement means is proposed (Patent Document 1).

### CITATION LIST

### Patent Literature

Patent Document 1: JP 2016-71660A

### SUMMARY OF INVENTION

However, the device of Patent Document 1 has a problem because this device cannot know which EC site a credit card is registered in. Specifically, if registering a plurality of credit cards in a plurality of EC sites provided from various web servers, one credit card holder may forget which credit card is registered in which EC site.

In view of the above-mentioned problem, an objective of the present invention is to provide a system, a method, and a program for displaying the registration status of a credit card that collect and organize the registration status of a credit card in an EC site and display the registration status by a credit card.

### SUMMARY OF INVENTION

The first aspect of the present invention provides a system for displaying the registration status of a credit card, including:

a receiving unit that receives a credit card to be registered;

an EC site registration unit that registers the received credit card in a predetermined EC site;

a collection unit that collects the registration status of the plurality of credit cards registered in the plurality of EC sites, the plurality of credit cards being received and registered in the EC sites; and

a display unit that organizes and displays the collected registration status by a credit card.

According to the present invention, the users who use EC sites can display which EC site their credit cards are each registered in.

### BRIEF DESCRIPTION OF DRAWINGS

FIG. 1 shows one example to display the registration status of a credit card.

### DESCRIPTION OF EMBODIMENTS

Embodiments of the present invention will be described below. However, this is illustrative only, and the technological scope of the present invention is not limited thereto.

The system for displaying the registration status of a credit card of the present invention displays the registration status of a credit card in an EC site.

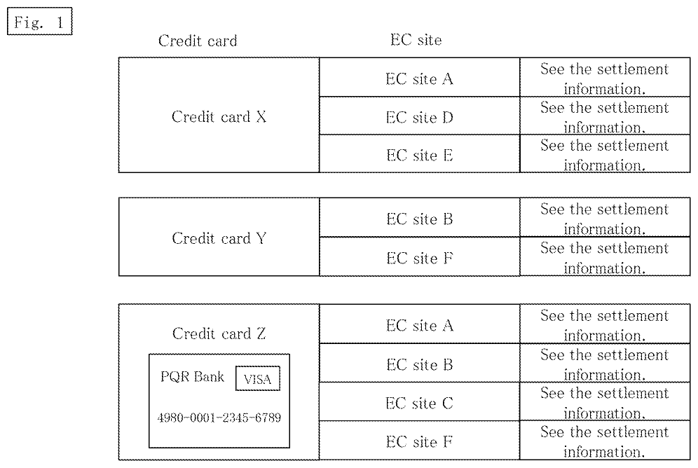

A preferable embodiment of the present invention will be described below with reference to FIG. 1. FIG. 1 shows one example to display the registration status of a credit card in a preferable embodiment of the present invention.

The system for displaying the registration status of a credit card includes a receiving unit, a registration unit, a collection unit, and a display unit that are achieved when the control unit reads a predetermined program. The system may also include an assigning unit. These units may be of an application type, a cloud type, or any other type. The above-mentioned units may each be achieved by a single computer or two or more computers (e.g., a server and a terminal).

The receiving unit receives a credit card to be registered. The type of the received credit card to be registered is not considered. The receiving unit is achieved by a browser on a computer terminal such as a smart phone, which receives the registration that is input from the user. Then, the receiving unit accesses a predetermined computer from the browser to display a page about registration of a credit card and receives an input. The accessed predetermined computer may be a web server that provides an EC site to be described later.

The registration unit registers the received credit card in an EC site. The registration unit may register the received credit card in an EC site retrieved by using the search engine. The registration unit may use the search engine owned by the system or may cooperate with an external search engine. Alternatively, the registration unit may prepare the list of EC sites in which credit cards can be registered, select an EC site from the list, and register the received credit card in the selected EC site. The registration unit may prepare a list to identify an EC site offering or not offering a benefit.

The collection unit collects the registration status of the plurality of credit cards registered in the EC sites. The collection unit may monitor the EC site in which a plurality of credit cards are registered and collect the registration status of the plurality of credit cards. Alternatively, the collection unit may collect the registration status of a plurality of credit cards based on the account information of the EC sites in which the plurality of credit cards are registered. The collection unit may collect settlement information in addition to registration status. The EC site in which a plurality of credit cards are registered makes the collection unit easy to monitor the EC site and access to the account information.

The display unit organizes and displays the collected registration status by a credit card. To know which credit card is registered in which EC site, the registration status is required to be organized by a credit card. The display unit may acquire and display the image of the face of a credit card. The image enables the user to visually know which the credit card is. As shown in FIG. 1, the organized credit cards and the EC sites in which each of the credit cards is registered are displayed.

If registration status and settlement information are collected, the display unit may organize and display the collected registration status associated with the collected settlement information by a credit card. In this case, the settlement information can be clarified in addition to the registration status. The display unit may display the credit card with the most settlements that is obtained from the settlement information at the top. Alternatively, the display unit may display the credit card with the nearest final settlement day that is obtained from the settlement information at the top. As shown in FIG. 1, the organized credit cards, the EC sites in which each of the credit cards is registered, and the settlement information are displayed. For example, the details can be viewed by pressing “See the settlement information.”

The display unit may acquire the images of a plurality of credit cards and organize and display the collected registration status together with their image by a credit card. FIG. 1 shows that the acquired image of the credit card Z is displayed. The image may be analyzed to judge whether or not the image corresponds to the credit card. Machine learning increases the probability that the image corresponds to the credit card.

The assigning unit assigns a link to the web content that explains the article for which the settlement was made to the displayed settlement information. This enables the user to confirm what the article for which the settlement was made is. The system may prepare the web content that explains the article for which the settlement was made and assign a link to the web content. If there is an article introduction page in the homepage of the cooperation that sells the article, a link may be assigned to the article introduction page. For example, as shown in FIG. 1, in a detailed page opened by pressing “See the settlement information,” a link to the web content that explains the article is assigned to the article in the detailed page.

The receiving unit may receive a plurality of credit cards to be registered and the priority for the credit cards. In this case, the display unit organizes and displays the collected registration status by a credit card in order of the received priority. Specifically, if the receiving unit receives the credit cards X, Y, and Z to be registered and the priority order of the credit cards Y, Z, and X, the display unit organizes and displays the collected registration status by a credit card in order of the credit cards Y, Z, and X from the top.

### Process Behavior

The method for displaying the registration status of a credit card will be described below. This is to display the registration status of a credit card in an EC site.

The method for displaying the registration status of a credit card includes a receiving step, a registration step, a collection step, and a display step. The method may also include an assigning step.

In the receiving step, the above-mentioned receiving unit receives a credit card to be registered. The type of the received credit card to be registered is not considered.

In the registration step, the above-mentioned registration unit registers the received credit card in an EC site. The registration unit may register the received credit card in an EC site retrieved by using the search engine. The registration unit may use the search engine owned by the system or may cooperate with an external search engine. Alternatively, the registration unit may prepare the list of EC sites in which credit cards can be registered, select an EC site from the list, and register the received credit card in the selected EC site. The registration unit may prepare a list to identify an EC site offering or not offering a benefit.

In the collection step, the above-mentioned collection unit collects the registration status of the plurality of credit cards registered in the EC sites. The collection unit may monitor the EC sites in which the plurality of credit cards are registered and collect the registration status of the plurality of credit cards. Alternatively, the collection unit may collect the registration status of a plurality of credit cards based on the account information of the EC sites in which the plurality of credit cards are registered. The collection unit may collect settlement information in addition to registration status. The EC sites in which the plurality of credit cards are registered make the collection unit easy to monitor the EC site and access to the account information.

In the display step, the above-mentioned display unit organizes and displays the collected registration status by a credit card. To know which credit card is registered in which EC site, the registration status is required to be organized by a credit card. The display unit may acquire and display the image of the face of a credit card. The image enables the user to visually know which the credit card is. As shown in FIG. 1, the organized credit cards and the EC sites in which each of the credit cards is registered are displayed.

In the display step, if registration status and settlement information are collected, the display unit may organize and display the collected registration status associated with the collected settlement information by a credit card. In this case, the settlement information can be clarified in addition to the registration status. The display unit may display the credit card with the most settlements that is obtained from the settlement information at the top. Alternatively, the display unit may display the credit card with the nearest final settlement day that is obtained from the settlement information at the top. As shown in FIG. 1, the organized credit cards, the EC sites in which each of the credit cards is registered, and the settlement information are displayed. For example, the details can be viewed by pressing “See the settlement information.”

In the display step, the display unit may acquire the images of a plurality of credit cards and organize and display the collected registration status together with their image by a credit card. FIG. 1 shows that the acquired image of the credit card Z is displayed. The image may be analyzed to judge whether or not the image corresponds to the credit card. Machine learning increases the probability that the image corresponds to the credit card.

In the assigning step, the assigning unit assigns a link to the web content that explains the article for which the settlement was made to the displayed settlement information. This enables the user to confirm what the article for which the settlement was made is. The system may prepare the web content that explains the article for which the settlement was made and assign a link to the web content. If there is an article introduction page in the homepage of the cooperation that sells the article, a link may be assigned to the article introduction page. For example, as shown in FIG. 1, in a detailed page opened by pressing “See the settlement information,” a link to the web content that explains the article is assigned to the article in the detailed page.

In the receiving step, the receiving unit may receive a plurality of credit cards to be registered and the priority for the credit cards. In this case, the display step organizes and displays the collected registration status by a credit card in order of the received priority. Specifically, if the receiving step receives the credit cards X, Y, and Z to be registered and the priority order of the credit cards Y, Z, and X, the display step organizes and displays the collected registration status by a credit card in order of the credit cards Y, Z, and X from the top.

To achieve the means and the functions that are described above, a computer (including a CPU, an information processor, and various terminals) reads and executes a predetermined program. For example, the program may be an application installed in a computer, may be provided through Software as a Service (SaaS), specifically, from a computer through a network, or may be provided in the form recorded in a computer-readable medium such as a flexible disk, CD (e.g., CD-ROM), or DVD (e.g., DVD-ROM, DVD-RAM). In this case, a computer reads a program from the record medium, forwards and stores the program to and in an internal or an external storage, and executes it. The program may be previously recorded in, for example, a storage (record medium) such as a magnetic disk, an optical disk, or a magnetic optical disk and provided from the storage to a computer through a communication line.

As the specific algorithm of the above-mentioned machine learning, the nearest neighbor algorithm, the naive Bayes algorithm, the decision tree, the support vector machine, etc. may be used. Furthermore, the machine learning may be the deep learning that generates the feature amount for learning by using the neural network.

The embodiments of the present invention are described above. However, the present invention is not limited to the above-mentioned embodiments. The effect described in the embodiments of the present invention is only the most preferable effect produced from the present invention. The effects of the present invention are not limited to those described in the embodiments of the present invention.

1. A system for displaying the registration status of a credit card, comprising:
a receiving unit that receives a credit card to be registered;
an EC site registration unit that registers the received credit card in a predetermined EC site;
a collection unit that collects the registration status of the plurality of credit cards registered in the plurality of EC sites, the plurality of credit cards being received and registered in the EC sites; and
a display unit that organizes and displays the collected registration status by a credit card, acquires the images of the plurality of credit cards, displays the images that correspond to the respective credit cards, together with the collected registration situation, and judges whether or not the images correspond to the respective credit cards.

2. The system according to claim 1, wherein the registration unit registers the received credit card in an EC site retrieved by using the search engine.

3. The system according to claim 1, wherein the registration unit registers the received credit card in an EC site selected from the list of EC sites in which a credit card can be registered.

4. The system according to claim 1, wherein the collection unit accesses the EC sites in which the plurality of credit cards are registered and collects the registration status of the plurality of credit cards registered in the EC sites.

5. The system according to claim 1, wherein the collection unit accesses the EC sites in which the plurality of credit cards are registered and collects registration status and settlement information on the plurality of credit cards registered in the EC sites, and the display unit organizes and displays the collected registration status associated with the collected settlement information by a credit card.

6. The system according to claim 1, wherein the collection unit collects the registration status of a plurality of credit cards based on account information on the EC sites in which the plurality of credit cards are registered.

7. The system according to claim 1, wherein the collection unit collects the registration status and the settlement information of a plurality of credit cards based on account information on the EC sites in which the plurality of credit cards are registered, and the display unit organizes and displays the collected registration status associated with the collected settlement information by a credit card.

8. The system according to claim 5, wherein the display unit displays the credit card with the most settlements that is obtained from the settlement information at the top.

9. The system according to claim 5, wherein the display unit displays the credit card with the nearest final settlement day that is obtained from the settlement information at the top.

10. The system according to claim 1, wherein machine learning is used to judge whether or not the images correspond to the respective credit cards by image analysis.

11. The system according to claim 5, further comprising an assigning unit that assigns a link to the web content that explains the article for which the settlement was made to the displayed settlement information.

12. The system according to claim 1, wherein the receiving unit receives a plurality of credit cards to be registered and the priority for the credit cards, and the display unit displays the collected registration status in order of the received priority.

13. A method for displaying the registration status of a credit card, comprising the steps of:
receiving a credit card to be registered;
registering the received credit card in a predetermined EC site;
collecting the registration status of the plurality of credit cards registered in the plurality of EC sites, the plurality of credit cards being received and registered in the EC sites; and
organizing and displaying the collected registration status by a credit card, acquiring the images of the plurality of credit cards, displaying the images that correspond to the respective credit cards, together with the collected registration situation, and judging whether or not the images correspond to the respective credit cards.

14. A program causing a computer to execute the steps of:
receiving a credit card to be registered;
registering the received credit card in a predetermined EC site;
collecting the registration status of the plurality of credit cards registered in the plurality of EC sites, the plurality of credit cards being received and registered in the EC sites; and
organizing and displaying the collected registration status by a credit card, acquiring the images of the plurality of credit cards, displaying the images that correspond to the respective credit cards, together with the collected registration situation, and judging whether or not the images correspond to the respective credit cards.
